(19) United States
(12) Patent Application Publication
(10) Pub. No.: US 2017/0140472 A1
(43) Pub. Date: May 18, 2017

(54) METHOD AND SYSTEM FOR ASSESSING AUDITING LIKELIHOOD

(71) Applicants: Massachusetts Institute of Technology, Cambridge, MA (US); The Mitre Corporation, McLean, VA (US)

(72) Inventors: Erik Anders Pieter Hemberg, Belmont, MA (US); Una-May O'Reilly, Weston, MA (US); Jacob Benjamin Rosen, Cambridge, MA (US); Osama Badar, San Francisco, CA (US); Hattithanthrige S. Wijesinghe, Silver Spring, MD (US); Geoffrey Lee Warner, Vienna, VA (US); Uma B. Marques, Leesburg, VA (US)

(73) Assignees: Massachusetts Institute of Technology, Cambridge, MA (US); The Mitre Corporation, McLean, VA (US)

(21) Appl. No.: 15/353,003

(22) Filed: Nov. 16, 2016

Related U.S. Application Data
(60) Provisional application No. 62/255,785, filed on Nov. 16, 2015.
(60) Provisional application No. 62/255,801, filed on Nov. 16, 2015.

(51) Int. Cl. G06Q 40/00

(52) U.S. Cl. CPC G06Q 40/123

(57) ABSTRACT

A method includes mapping a first subset of integers to a plurality of transaction sequences, mapping a second subset of integers to a plurality of audit score sheets and quantitatively analyzing each respective one of the mapped transaction sequences relative to each respective one of the mapped audit score sheets to determine an objective score for each one of the transaction sequences and each one of the audit score sheets. The objective score for each one of the mapped transaction sequences is a function of an estimated tax liability and likelihood of being audited associated with that mapped transaction sequence. The objective score for each one of the mapped audit score sheets is a function of an estimated effectiveness associated with that audit score sheet. The method further includes generating a new population of effective transaction sequences and/or effective auditing policies based on the objective scores.

### CROSS-REFERENCE TO RELATED APPLICATIONS

This application claims the benefit of U.S. Provisional Patent Application Ser. No. 62/255,785, filed Nov. 16, 2015, entitled “METHOD AND SYSTEM FOR ASSESSING AUDITING LIKELIHOOD,” and U.S. Provisional Patent Application Ser. No. 62/255,801, filed Nov. 16, 2015, entitled “SYSTEM AND METHOD FOR EXTRACTING AND PROVIDING A MEASURE OF TAXABLE INCOME AND AUDIT LIKELIHOOD”, both of which are incorporated by reference herein in their entirety.

### FIELD OF THE INVENTION

This disclosure relates to a method and system for assessing auditing likelihood. In some instances, this may involve identifying effective strategies for accomplishing an economic goal, while reducing or minimizing tax liability and the likelihood of being audited. In some instances, this may involve identifying effective tax auditing policies to help facilitate the efficient allocation of limited auditing resources.

### BACKGROUND

Abusive tax shelters are investment schemes that claim to reduce income tax without changing the value of the user's income or assets. Generally speaking, abusive tax shelters serve no economic purpose other than lowering the federal or state tax owed when filing. Sometimes, these schemes channel funds through trusts or partnerships, for example, to avoid being taxed.

In the United States, a tax audit is an examination of a business or individual tax return by the Internal Revenue Service (IRS) or state tax authority, for example. One goal of a tax audit is to evaluate whether filings to the IRS or state tax authorities are correct according to applicable tax laws.

### SUMMARY OF THE INVENTION

In one aspect, a method includes mapping a first subset of integers to a plurality of transaction sequences, mapping a second subset of integers to a plurality of audit score sheets and quantitatively analyzing each respective one of the mapped transaction sequences relative to each respective one of the mapped audit score sheets to determine an objective score for each one of the transaction sequences and each one of the audit score sheets. The objective score for each one of the mapped transaction sequences is a function of an estimated tax liability and likelihood of being audited associated with that mapped transaction sequence. The objective score for each one of the mapped audit score sheets is a function of an estimated effectiveness associated with that audit score sheet. The method further includes generating a new population of effective transaction sequences and/or effective auditing policies based on the objective scores.

Systems (and software) for conducting this method, and variations thereof, are described herein as well.

In some implementations, as described herein the system works with the TACTIC system (shown in the figures and described in detail in another application, U.S. Provisional Patent Application No. 62/255,801 (and its related US non-provisional patent application), which are incorporated by reference herein in their entirety), and includes essentially seven modules working together to accomplish a common purpose. That purpose is, given the notions of taxable income and audit score, finding “effective” transaction sequences that minimize both their tax liability (taxable income) and likelihood of being audited (audit score). Conversely, the system also allows one to find “effective” auditing policies that reduce both false negatives and false positives pertaining to abusive tax shelters. Together they serve to anticipate new iterations of abusive tax avoidance schemes.

In some implementations, the first two modules pertain to the numerical representation of transaction sequences and auditing policies. The next two modules pertain to the establishment of metrics for “effective” tax avoidance schemes and auditing policies. The remaining three modules describe the search heuristics by which solutions for optimal tax avoidance schemes and auditing policies are found.

According to some implementations, in order to conduct the search heuristic d, there must be a method by which an integer vector (e.g., a sequential list of n integers) can be uniquely mapped to a transaction sequence. In some instances, this is accomplished by defining a context-free grammar, which maps an integer vector to a transaction sequence via modular algebra. Next, a unique mapping is established between an integer vector and audit score sheets. This is accomplished by a context free grammar as well that may be fairly basic.

The establishment of a numerical measure of “effectiveness” for a tax avoidance scheme is a non-trivial problem that is a function of: a) measures of taxable income of the relevant entities, and b) audit score sheets' (that records the activity of the transaction sequence) weights and corresponding observable frequency. In some instances, only the audit score is used as a measure of audit likelihood, but any function of observable weights and frequency can be used. Depending on the situation at hand, this numerical measure can be different functions, but the basic concepts underlying the measure are shown in FIG. 10. Generally speaking, a highly effective “high fitness” scheme will produce relatively low levels of taxable income, while generating a low likelihood of being audited. Conversely, a highly ineffective “low fitness” scheme will also produce low relative levels of taxable income, but generates high audit likelihoods.

Transaction sequences that produce normal levels of taxable income have a slight preference for low levels of audit likelihood, and those that produce higher than average taxable income levels are discouraged by the effectiveness measure.

Similarly, a measure of effectiveness for auditing policies can be established. In one example, the inputs to this measure are the same as that for transaction sequences, that is: a) measure of taxable income from the transaction sequence being compared, and b) information regarding the audit score sheet's weights and corresponding frequencies. Measures for effectiveness for audit score sheets generally take into account both false negatives and false positives regarding transaction sequences they are compared against. To protect against false negatives, the measure of auditing policy effectiveness should be high when the level of taxable income generated is relatively low. Conversely, false positives are taken into account by assigning a low effectiveness measure when the level of taxable income is relatively normal high. The concept is shown further in FIG. 11.

Effective transaction sequences can be found via grammatical evolution, as described more in depth elsewhere herein. Prior to the evaluation step, the vectors are mapped to transaction sequences and evaluated for both taxable income and audit score against the same audit score sheet for all members of a population. Generally speaking, the most effective transaction sequences are then recombined and mutated to form a new population, then the whole process is repeated.

Generally speaking, effective audit score sheets may be found via grammatical evolution described elsewhere herein. Prior to the evaluation step, the vectors are mapped to audit score sheets and evaluated for both the audit score and taxable income measure against a specific transaction sequence that is held static for the entire process. The most effective audit score sheets may be then recombined and mutated to form a new population, then the whole process is repeated.

Co-evolving transaction sequences and audit score sheets are described elsewhere herein. There are two populations: integer vectors corresponding to transaction sequences and integer vectors corresponding to audit score sheets. First, each transaction sequence from the population chooses a subset of the audit score sheet population to compare itself against, so the objective score for transaction sequences in this case is the sum (or some other function of) the objective scores. Similarly, each audit score sheet from the population selects a subset of the transaction sequence population to compare itself against, and its objective score is some function of the objective scores. After this process is done for all members of both populations, the best elements from both populations are combined and mutated, then the process can continue indefinitely.

Other features and advantages will be apparent from the description and drawings, and from the claims.

### BRIEF DESCRIPTION OF THE DRAWINGS

FIG. 1 is a flowchart that represents an exemplary implementation of a computer-based method that, in various implementations, facilitates evaluating the complex, coevolving relationship between tax evasion schemes and tax auditing policies.

FIG. 2 illustrates the decoding of a list of integers given a transformation by context-free-grammar.

FIG. 3 is a schematic representation of the TACTIC sub-system 108 functionalities.

FIG. 4 is a flowchart representing some of the steps involved in a particular implementation of the techniques represented in FIG. 1.

FIG. 5 is a flowchart representing some of the steps involved in a particular implementation of the techniques represented in FIG. 1.

FIG. 6 shows a schematic representation of an exemplary method for concurrently searching a set of lists of transactions and a set of lists of audit observables.

FIG. 7 is a schematic representation of an exemplary computer-based system that may be configured to implement functionalities as disclosed, for example, in connection with FIG. 1.

FIG. 8 is a schematic representation of an exemplary computer-based user-interface.

FIG. 9 is a schematic representation showing how a pool of transaction sequences co-evolves with a pool of audit score sheets by selecting subsets of one another's populations.

FIG. 10 is a graphical representation of taxable income and audit score.

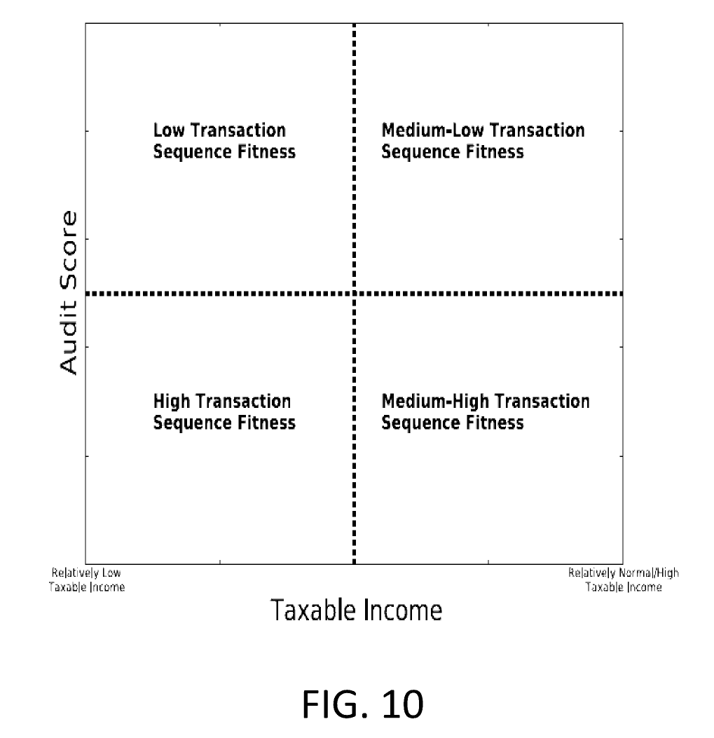

FIG. 11 is another graphical representation of taxable income and audit score.

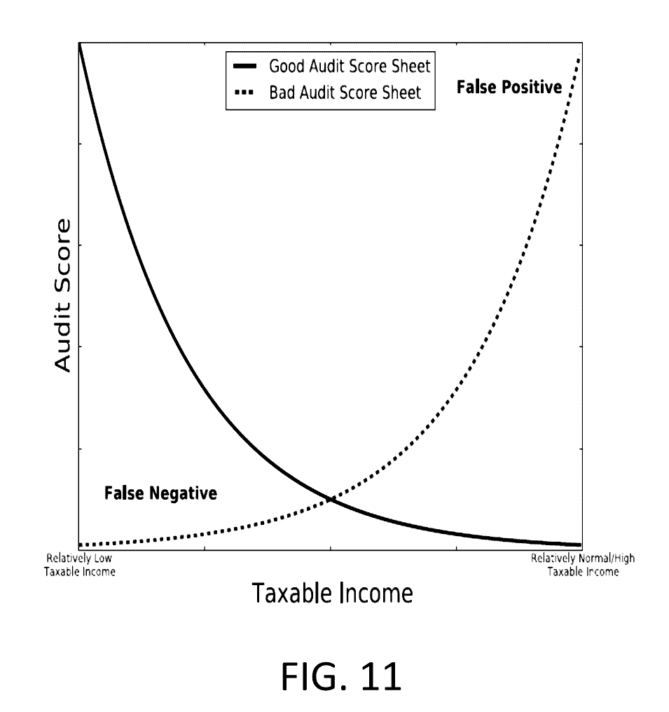

### DETAILED DESCRIPTION

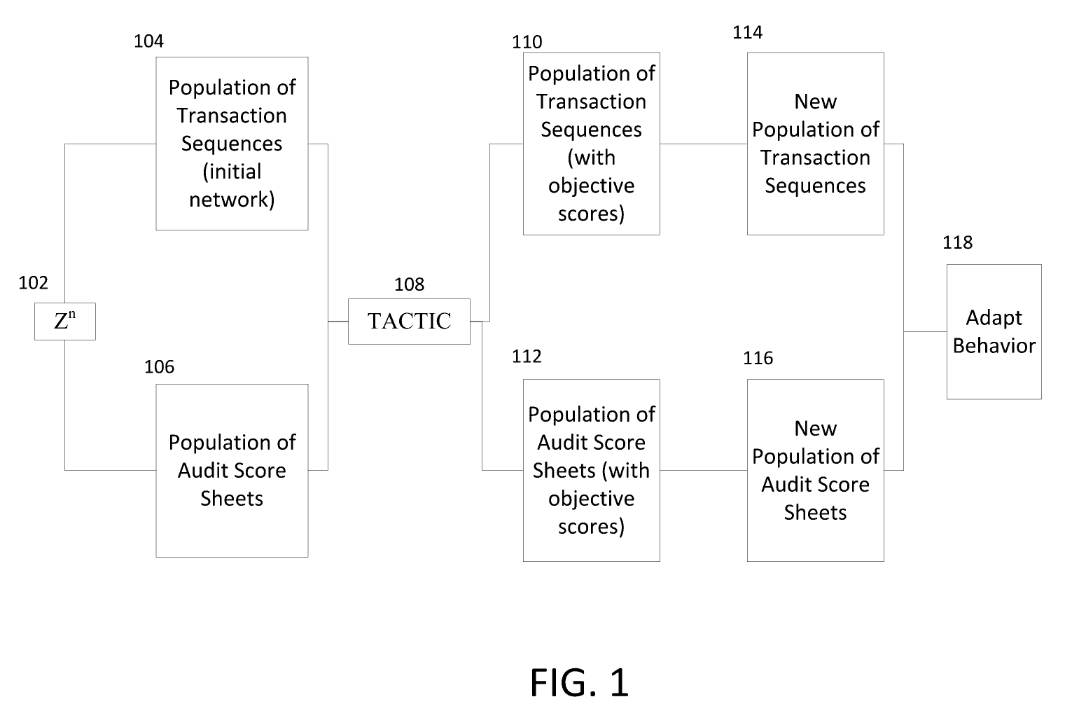

Traditionally, tax avoidance schemes (e.g., abusive tax shelters or the like) have evolved to get around or avoid new tax laws and tax auditing policies. Similarly, tax laws and tax auditing policies (dictating, e.g., what an IRS auditor might pay close attention to) have evolved to try to identify these evolving tax avoidance schemes, particularly schemes like abusive tax shelters, so that tax revenue for the government can be collected appropriately. FIG. 1 is a flowchart that represents an exemplary implementation of a computer-based method that, in various implementations, facilitates evaluating the complex, coevolving relationship between tax evasion schemes and tax auditing policies.

In some implementations, the techniques represented in the illustrated figure can be applied to help IRS auditors maximize the efficient allocation of their often rather limited auditing resources. Moreover, in some implementations, the techniques represented in the illustrated figure can be applied to help taxpayers effectively structure their transactions to achieve economic goals in a manner that minimizes risk of scrutiny by IRS auditors under applicable tax laws and/or auditing policies, while also minimizing their associated tax liability.

Generally speaking, tax avoidance schemes and tax laws and auditing policies are highly qualitative concepts. The techniques represented in the illustrated flowchart, however, provide for a quantitative approach to analyzing the effectiveness of these tax avoidance schemes and tax laws and auditing policies. For example, in a typical implementation an abusive tax shelter can be represented quantitatively as a sequence of transactions mapped to an integer vector. Likewise, in a typical implementation, tax laws and/or tax auditing policies can be represented quantitatively by audit score sheets (each having a list of activities with correlated weights associated with each activity) mapped to an integer vector.

Ultimately, the illustrated techniques help facilitate identifying effective tax laws and/or tax auditing policies and/or effective ways to reduce tax liability and likelihood of being audited when working toward an economic goal. The concept of effectiveness in these regards, and as used throughout this document, should be construed broadly and, of course, can mean different things, depending on whether one is referring to a tax auditing policy or a way to reduce tax liability and likelihood of being audited when working toward an economic goal. For example, a particular taxpayer scheme might be considered effective if it accomplishes an economic goal (e.g., the sale of a partnership interest), without incurring high tax liability, and while avoiding or minimizing the likelihood of IRS scrutiny under existing, applicable tax laws and auditing policies. A tax auditing policy, on the other hand, might be considered effective if, for example, it successfully flags every, or most, abusive or likely abusive taxpayer schemes without unnecessarily flagging any taxpayer schemes that are clearly not abusive. In a typical implementation, the techniques represented in the illustrated flowchart pit various transaction sequences associated with different schemes against various tax laws and/or auditing policies to help gage effectiveness in these regards and to help provide users with a better understanding of what makes certain schemes effective and what makes certain tax laws and/or auditing policies effective.

Tax evasion schemes, such as abusive tax shelters or the like, can be highly complex, as can the tax laws and auditing policies that may be relevant to those tax evasion schemes. Generally speaking, the techniques represented in the illustrated flowchart are not intended to identify with certainty whether a particular set of circumstances is abusive or not. Instead, the techniques provide a quantitative approach to give auditors and taxpayers, for example, additional insights to better understand and manage their actions and to better understand possible ramifications thereof, within this highly complex environment.

Referring now to FIG. 1, the illustrated techniques include, at 102, generating one or more integer vectors Zⁿ. Generally speaking, an integer vector is a list of integers. In a typical implementation, to initiate the process, the integer vectors Zⁿ are randomly generated, with a computer-based processor, for example.

According to the illustrated flowchart, some of the generated integers are mapped (at 104) to population of transaction sequences. The population of transaction sequences can include, for example, a listing of steps or “transactions” performed by a party (e.g., a taxpayer) to achieve one or more economic goals. The transactions may be actual steps performed or steps that may be possible or being contemplated. In a typical implementation, information about the transactions sequences will have been entered by one or more users (e.g., taxpayer(s), auditor(s), other(s)), for example, from a computer-based user interface, like a laptop or desktop computer or a smartphone, etc.

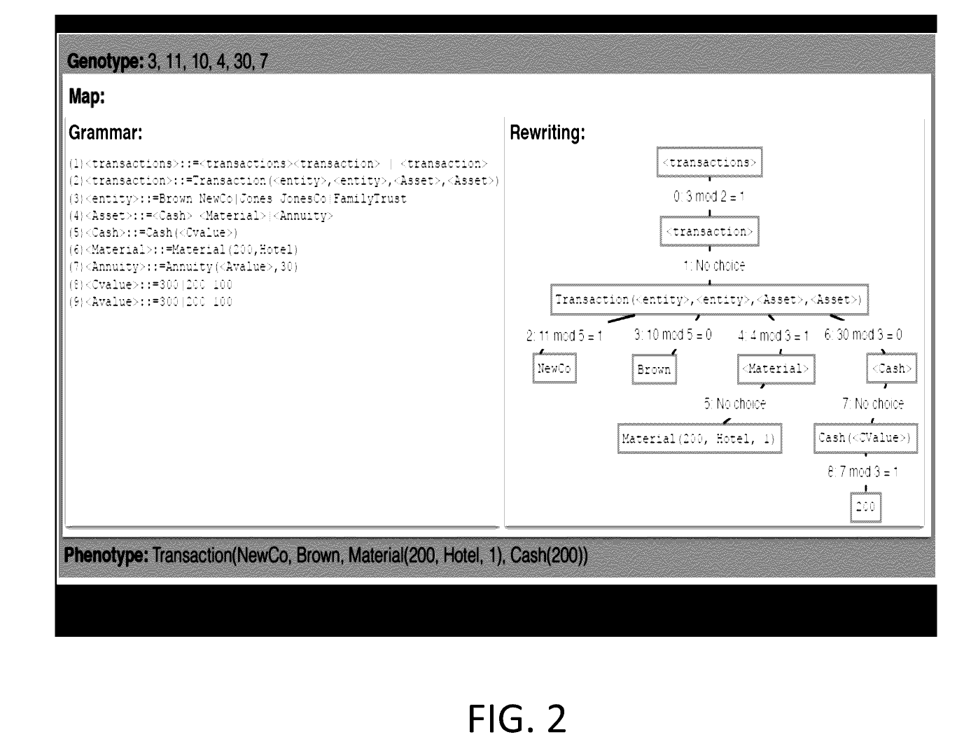

In a typical implementation, mapping the integers to the transaction sequences is accomplished using a generative grammar function. Generally speaking, generative grammar refers to a linguistic theory that considers grammar to be a system of rules that is intended to generate exactly those combinations of words that form grammatical sentences in a given language. An example of a generative grammar that may be useful in this regard is shown in FIG. 2.

More particularly, FIG. 2 illustrates the decoding of a list of integers given a transformation by context-free-grammar in Backus Naur Form to a list of transactions. In the illustrated example, a binary string functions as an indirect representation. The binary string is first represented as integer. In the next step the method decodes the binary string into a list of transactions using a set of rewriting rules according to the context-free grammar. The BNF-grammar uses the list of integers (genotype) to map the start symbol into a sentence. The mapping is done by reading an integer from the list as input to choose a production rule by taking the current integer input and the modulo of the number of production choices for the current non-terminal symbol. Each time a production from a rule with more than one production choice is selected to transform a non-terminal, another integer is read. The rewriting terminates when there are no more non-terminal symbols to rewrite.

There is an example of the rewriting of an integer list (genotype) to a sentence phenotype describing a transaction between two entities that exchange assets.
1. We pick the first rule in the grammar as the start symbol, in this case (1) <transactions>.
2. Expand the left most non-terminal symbol in our sentence <transactions>. We take the current integer input 3 and the modulo of the number of production choices 2, which is 1. Thus, we pick <transaction> the production choice at position 1 (the indexing starts at 0) and rewrite the <transactions> with <transaction>.
3. Again expand the left most non-terminal symbol <transaction>. There is only one production choice here, so it is rewritten to Transaction (<entity>, <entity>, <Asset>, <Asset>).
4. Again expand the left most non-terminal symbol <entity>. We take the current integer input 11 and the modulo of the number of production choices 5, which is 1, thus we pick NewCo. The sentence is now Transaction (NewCo, <entity>, <Asset>, <Asset>).
5. The left most non-terminal symbol is again <entity>. We take the current integer input 10 and the modulo of the number of production choices 5, which is 0, thus we pick Brown. The sentence is now Transaction (NewCo, Brown, <Asset>, <Asset>).
6. The left most non-terminal symbol is now <Asset>. We take the current integer input 4 and the modulo of the number of production choices 3, which is 1, thus we pick <Material>. The sentence is now Transaction (NewCo, Brown, <Material>, <Asset>).
7. The left most non-terminal symbol is now <Material>. There are no choices for <Material> so we rewrite it with Material (200, Hotel, 1). The sentence is now Transaction (NewCo, Brown, Material (200, Hotel, 1), <Asset>). 8. The left most non-terminal symbol is again <Asset>. We take the current integer input 30 and the modulo of the number of production choices 3, which is 0, thus we pick <Cash>. The sentence is now Transaction (NewCo, Brown, Material(200, Hotel, 1), <Cash>).
9. The left most non-terminal symbol is now <Material>. There are no choices for <Cash> so we rewrite it with Cash (<Cvalue>). The sentence is now Transaction (NewCo, Brown, Material(200, Hotel, 1), Cash(<CValue>).
10. The left most non-terminal symbol is Cash (<CValue>). We take the current integer input 7 and the modulo of the number of production choices 3, which is 1, thus we pick 200. The sentence is now Transaction (NewCo, Brown, Material(200, Hotel, 1), Cash(200).
11. There are no more non-terminal symbols left to rewrite and our string rewriting is done.

The space of possible transaction list combinations is represented by the possible output of the transformation rewrite rules.

Referring again to FIG. 1, according to the illustrated flowchart, some of the generated integers are mapped (at 106) to population of audit score sheets. Generally speaking, in a typical implementation, an audit score includes a list of audit points (weighted) that correspond to all of the detectable events that can possibly occur when a network of transactions is executed. Each audit point corresponds to a different type of event that may be present in a transaction. The higher the audit points associated with a certain type of event, the more suspicious that type of event is. In some implementations, the audit points are assigned so that they add up to one (or some other finite number), in order to mirror the limited resources available for auditing. The audit score associated with a sequence of transactions (and the associated audit score sheet) can be considered the sum of all the audit points present in the associated transaction sequence multiplied by their respective frequencies. Visually, an audit score sheet can be represented by a spreadsheet, with each row corresponding to a different type of audit observable as shown in Table 1. One can imagine a hypothetical auditor going through a network of transactions and incrementing the frequency in the far right column whenever each type of event is observed.

TABLE 1
Each row has the observable, the associated audit point
and the number of times it occurs in a sequence of transactions

| Observable | Point | Frequency |
|---|---|---|
| Activity₁ | Point₁ | Frequency₁ |
| . . . | . . . | . . . |
| Activityₙ | Pointₙ | Frequencyₙ |

Using this formulation, an audit score can be interpreted as the likelihood that a sequence of transactions will be audited. In this regard, the representation of audit points generally relies on the presence of “observable” events. In a typical implementation, an observable event is one that is possible to detect in the tax ecosystem model, but not necessarily by the IRS. For example, if a taxpayer purchases a share in a partnership for cash, that may be processed as a transaction involving a partnership asset, as well as all parties involved in the transaction, while an actual audit likely would require more effort to acquire the information.

In a typical implementation, the audit score sheet information will have been entered by one or more users (e.g., taxpayer(s), auditor(s), other(s)), for example, from a computer-based user interface, like a laptop or desktop computer or a smartphone, etc.

In a typical implementation, mapping the integers to the audit score sheets is more straightforward than mapping the integers to the transaction sequences. Generally speaking, in a typical implementation, if there are N observables, there will be 2^{N}−1 entries on the audit score sheet. In that example, each integer (2^{N}−1 of them in total) can be mapped directed to a corresponding one of the observables.

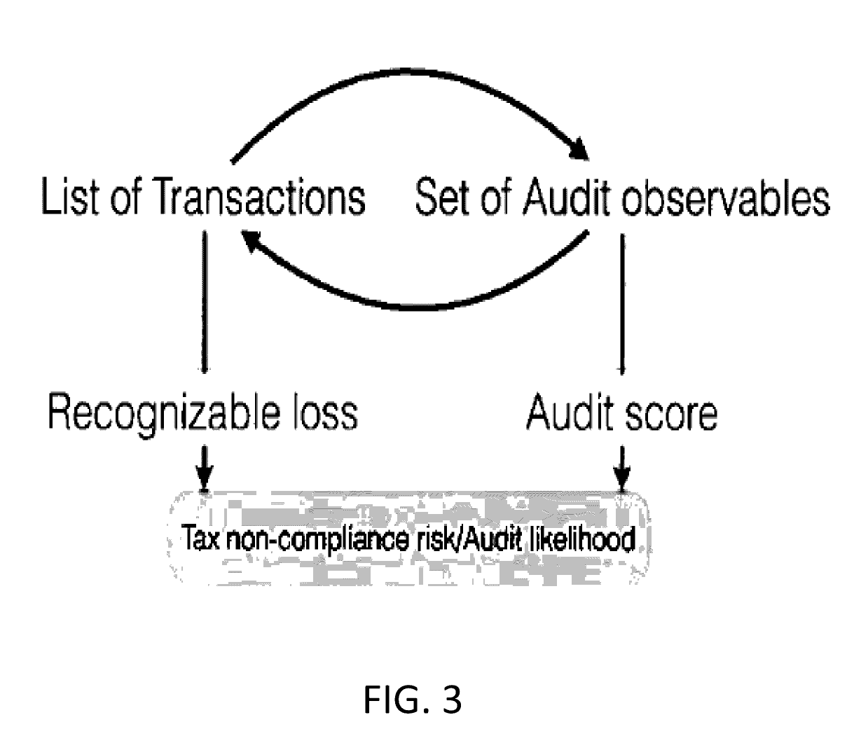

Next, at 108 in the flowchart of FIG. 1, the outputs from the mappings (at 104 and 106) are applied to a sub-system 108 (called “TACTIC” in the illustrated flowchart). Details of “TACTIC” sub-system 108 are provided in U.S. Provisional Patent Application No. 62/255,801 (and its related US non-provisional patent application). However, generally speaking, the TACTIC sub-system 108 is configured to quantitatively analyze the data input to it (from 104 and 106) and, for each respective one of the associated transaction sequences, to determine an estimated tax liability and a likelihood of being audited under existing tax laws and auditing policies. FIG. 3 is a schematic representation of the TACTIC sub-system 108 functionalities.

More particularly, FIG. 3 illustrates the evaluation of lists of transactions and sets of audit observables to give a quality measure of risk of being audited and likelihood of audit. Generally speaking, the main goal of the tax evader is to minimize audit likelihood and maximize deductible loss. Individual solutions in co-evolutionary search can be assigned with so called fitness functions. The fitness function in the tax ecosystem model takes into account variables that determine how desirable (or effective) a tax evasion scheme or an audit score sheet is. First of all, each set of transactions generates a deductible loss, dl. Secondly, an audit score sheet generates an audit score, s based on a list of transactions, which represents the likelihood that a scheme will be audited. i.e. the risk of being audited. Thus, we can represent the fitness function, hₑ for a tax evasion scheme, given a specific audit score sheet, as

hₑ=d_{L}(1−s)

Note that there are two terms in the function that affect a tax evasion scheme's fitness (effectiveness). First of all, fitness is positively correlated with the deductible loss, which is to be expected. A tax evasion scheme is only effective if it results in low taxable income. The second term in the function represents the likelihood of the audit disallowing the tax benefits gained from the scheme, which takes into account not only the likelihood of an audit (audit score), but also the amount of tax that is evaded. The logic is that there should be little reduction in fitness if little tax is evaded because there is a lower likelihood that an audit will result in a negative ruling. In this way, we are able to take into account both the effectiveness of a tax evasion scheme from a purely tax perspective, as well as from a risk perspective.

One goal of an auditor is to maximize the likelihood of an audit of a list of transactions with high deductible loss. The fitness function for an audit score sheet given a specific tax evasion scheme is the same as that shown above, but with the opposite sign

hₐ=−hₑ=−d_{L}(1−s)

Generally speaking, an audit score sheet is fit for a specific evasion scheme if either 1) there is a high level of recognizable gain 2) if there is a high likelihood that if not much tax is collected. Then the scheme may be audited.

Referring again to implementation in FIG. 1, a result of the functionalities applied by the TACTIC sub-system 108 in the illustrated flowchart is a population of transaction sequences (with objective scores—e.g., fitness functions hₑ) and a population of audit score sheets (also with objective scores, e.g., fitness functions hₐ).

Next, in the illustrated flowchart, the population of transaction sequences (with objective scores—e.g., fitness functions hₑ) and the population of audit score sheets (also with objective scores, e.g., fitness functions hₐ) are converted to a new population of transaction sequences (at 114) and a new population of audit score sheets (at 116), respectively. Generally speaking, the new population of transaction sequences (at 114) and the new population of audit score sheets (at 116) are intended to include the most effective transaction sequences and audit score sheets from the previous populations (i.e., at 104 and 106).

There are a variety of ways to accomplish the indicated conversions (from 110 to 114 on the one hand and from 112 to 116 on the other). However, in some implementations, the conversion involves mapping the population of transaction sequences (at 110) and the population of audit score sheets (at 112) back into the integer space and applying a genetic algorithm (or other evolutionary or non-linear search functionalities) to the resulting mapped populations. Generally speaking, a genetic algorithm is a search heuristic that mimics the process of natural selection. This heuristic is particularly helpful in generating useful solutions to optimization and search problems.

In a typical implementation, one genetic algorithm is applied to the population of transaction sequences with objective scores to identify the best (i.e., most effective) transaction sequence (or sequences) in the population. This produces the new population of transaction sequence(s) (at 114 in FIG. 1) that represent the most effective one(s). Moreover, in a typical implementation, another genetic algorithm is applied to the population of audit score sheets with objective scores to identify the best (i.e., most effective) audit score sheet (or audit score sheets) in the population. This produces the new population of audit score sheet(s) (at 116 in FIG. 1) that represent the most effective one(s).

Some of the functionalities represented in the illustrated flowchart may be performed iteratively. So, for example, in a typical implementation, once the new population of transaction sequences (at 114) and the new population of audit score sheets (at 116) are determined, these populations end being inserted back at the beginning of the process (e.g., at boxes 104 and 106) and the procedures described above is applied again using the new population of transaction sequences (at 114) and the new population of audit score sheets (at 116) as a starting point. This iterative process can, and typically does, continue for multiple generations until some halting condition is reached (e.g., a certain predefined number of generations have occurred, or some other measurable indicator is reached). In a typical implementation, each generation of results (e.g., 114 and 116 in FIG. 1) should be better than (e.g., more effective than) previous generations.

Finally, according to the illustrated flowchart, there is, at 118, an adjustment in behavior. Essentially, in response to the output provided, an auditor and/or a taxpayer may adjust his or her behavior.

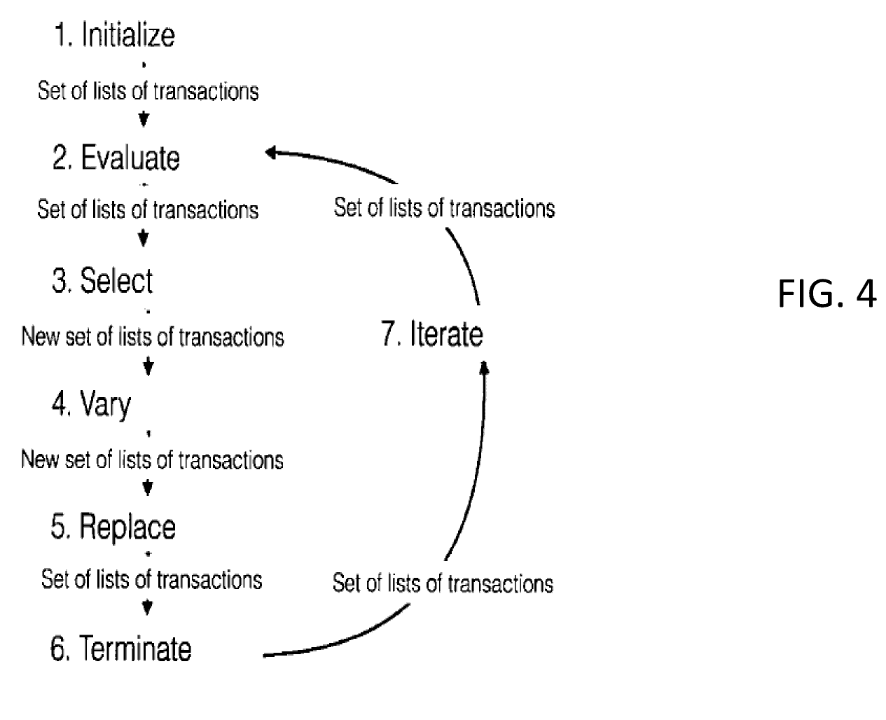

FIG. 4 is a flowchart representing some of the steps involved in a particular implementation of the techniques represented in FIG. 1. More particularly, the illustrated flowchart shows how a set of lists of transactions can be generated, evaluated, selected, modified and/or replaced. The steps in a single iteration (generation) of the illustrated method are:
1. Initialize: The initial set of lists of transactions is uniformly randomly-generated integer lists.
2. Evaluate: Each list of transactions is evaluated and assigned a score according to the deductible loss and audit score.
3. Select: Some lists of transactions from the current set are included in a new set.
4. Vary: Lists of transactions in the new set are modified. One variation may be to uniformly randomly select and generate new integer values. Another is to swap integer values between two lists of transactions.
5. Replace: Maintain the lists of transactions from the current set with the best quality (i.e., most effective). Replace the rest of the current set of lists of transactions with the new set of lists of transactions with the best quality.
6. Terminate: Stop if a termination criteria (or halting criteria) is met
7. Iterate: If no termination criteria, then return to step 2.

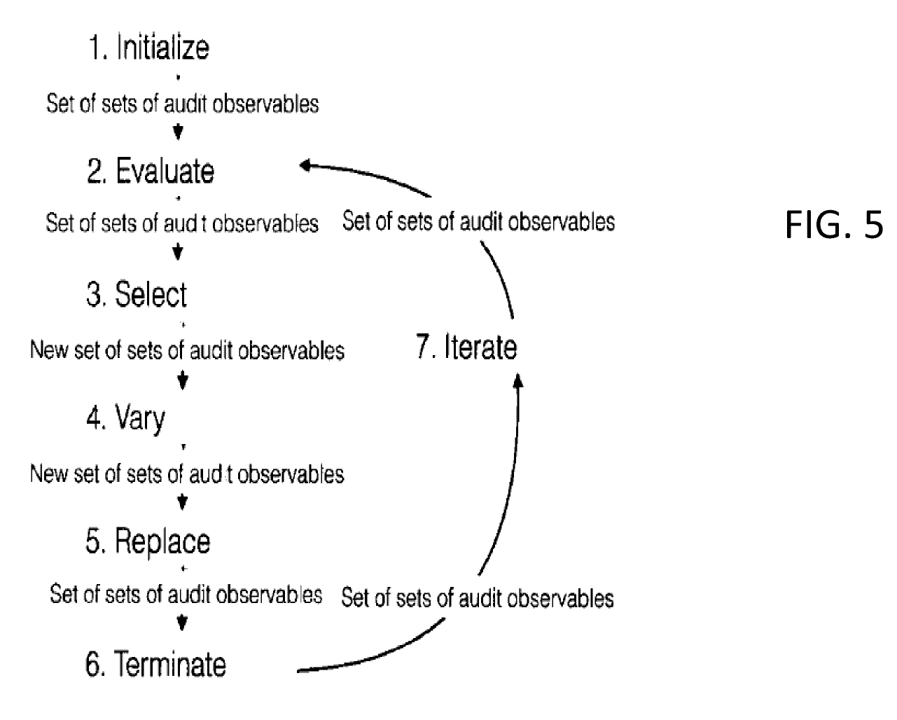

Similarly, FIG. 5 is a flowchart representing some of the steps involved in a particular implementation of the techniques represented in FIG. 1. More particularly, the illustrated flowchart shows how one or more sets of audit observables can be generated. evaluated, selected, modified and replaced. The steps in a single iteration (generation) are:
1. Initialize: The initial set of audit observables are uniformly randomly generated integer lists.
2. Evaluate: Each set of audit observables is evaluated and assigned a score according to the deductible loss and audit score.
3. Select: Some sets of audit observables from the current set are included in a new set.
4. Vary: Sets of audit observables in the new set are modified. One variation is to uniformly randomly selecting and generating new integer values. Another is to swap integer values between two sets of audit observables.
5. Replace: Maintain the sets of audit observables from the current set with the best quality. Replace the rest of the current set of audit observables with the new set of audit observables with the best quality.
6. Terminate: Stop if a termination criteria is met.
7. Iterate: If termination criteria is not met, return to step 2

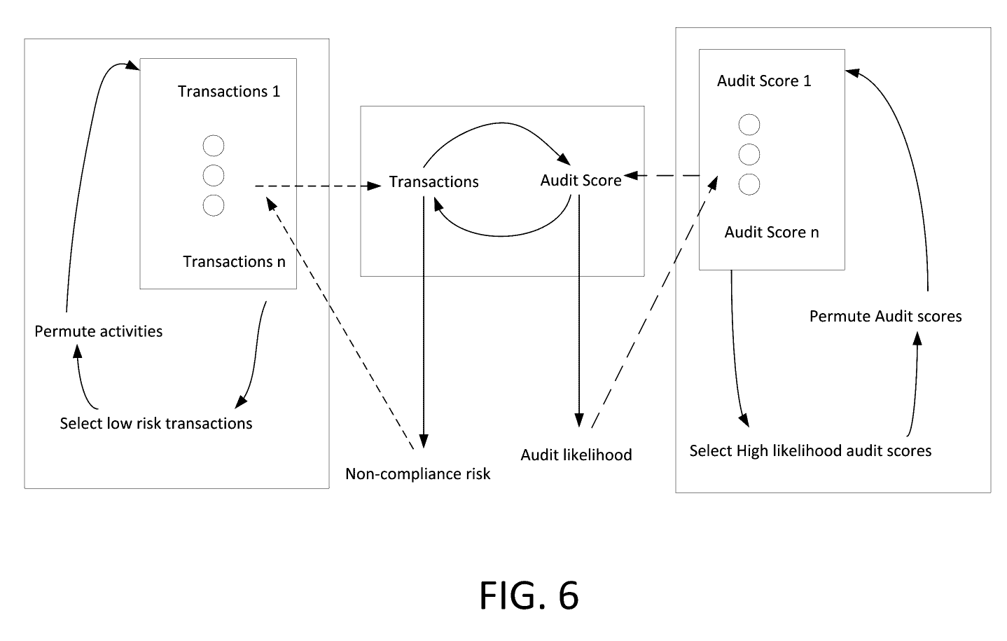

FIG. 6 shows a schematic representation of an exemplary method for concurrently searching a set of lists of transactions and a set of lists of audit observables. The method performs a co-evolution of a population of tax evasion schemes with a population of audit score sheets, both of which are evaluated in every step against a sub-population of the opposite agent type. That is, each tax evasion scheme “selects” some audit sheets to calculate its fitness. Similarly, each audit score sheet selects some tax evasion schemes to calculate its fitness.

The method performs a search on lists of transactions to find the specific sequence of transactions that maximize a quality score. A tax scheme generated by the method is represented by a list of integers. A parser is used to read these integers and generate a list of transactions with the help of a grammar. The transactions consist of a list of Java interpretable objects that are input to a tax simulator to calculate the resulting taxable gain. The parser in this case bridges the gap between the search and the tax ecosystem model. In this example, the transactions are described as consisting of list(s) of Java interpretable objects. Of course, the objects need not be Java interpretable. Instead, they can be in any programming language.

In order to run co-evolution, in the illustrated example, there are two sets: a) list of transactions and b) audit points. The mechanics of co-evolution calculates the quality of a list of transactions or a set of audit observables with a k size subset of the opposite population. In order to generate both a final taxable income value and an audit score, the tax ecosystem model takes both a list of transactions and audit points as inputs. As each transaction in the list is executed, the tax simulator calculates the audit score for the types of financial events indicated on the audit score sheet.

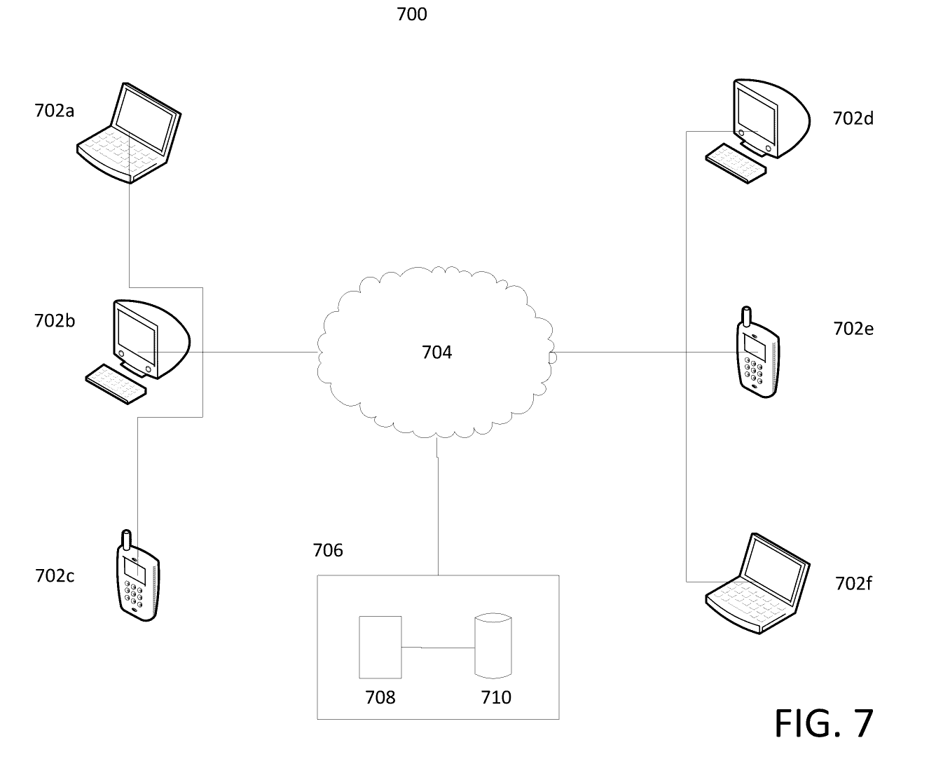

In some implementations, one or more (or all) of the steps represented in the flowchart of FIG. 1 are implemented, for example, by one or more computer-based processors in a computer-based network. An exemplary computer-based system 700 that may be configured to implement functionalities along these lines is shown in FIG. 7.

The illustrated system 700 includes a plurality of computer-based user interfaces 702a-702f, each of which may be a laptop or desktop computer, a tablet, a smartphone, etc. connected via a computer network 704 (e.g., the Internet) to each other and to a computer-based server 706 that includes one or more processors 708 and one or more electronic storage devices 710.

In the illustrated example, some of the computer-based user interfaces (702a-702c) are accessible and used by taxpayers, whereas others of the computer-based user interfaces (702d-702f) are accessible and used by auditors.

Information regarding and/or needed to create the population of transaction sequences for the initial network can be stored in one or more of the electronic storage devices 710. This information may be pre-loaded into the system, may be entered by one or more of the taxpayers, and/or may be entered by one or more of the auditors. In some implementations, this information is entered into the system in a number of different ways.

Information regarding and//or needed to create the population of audit score sheets can be stored in one or more of the electronic storage devices 710 as well. This information may be pre-loaded into the system, may be entered by one or more of the taxpayers, and/or may be entered by one or more of the auditors. In some implementations, this information is entered into the system in a number of different ways.

In a typical implementation, the system 700 is configured to enable the taxpayers to access functionalities (e.g., at one or more of the taxpayer user-interfaces 702a-702c) that help the taxpayers to figure out effective ways to achieve various desired economic goals. Moreover, in a typical implementation, the system 700 is configured to enable the auditors to access functionalities (e.g., at one or more of the auditor user-interfaces 702d-702f) that help the auditors figure out effective auditing policies, for example.

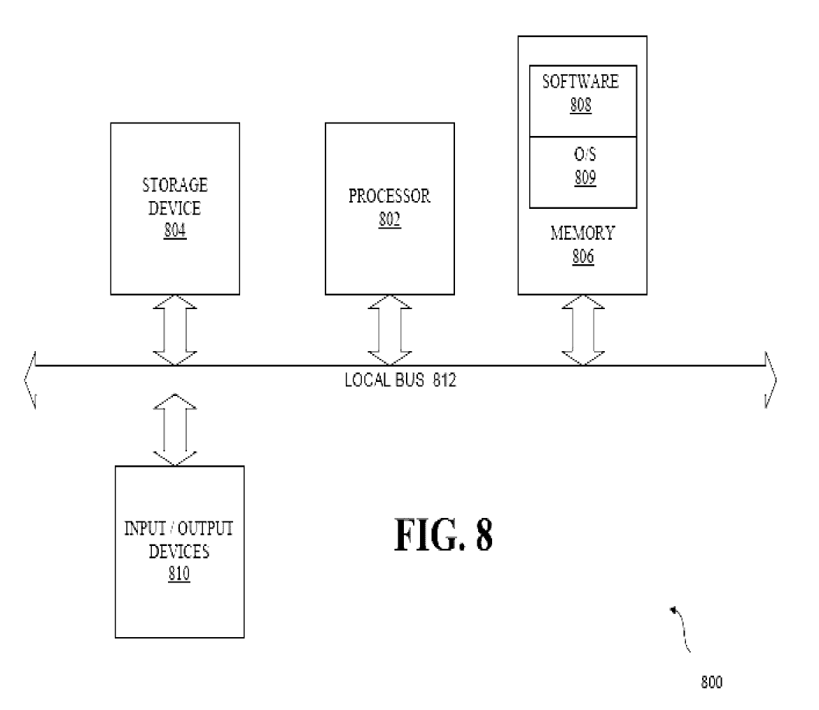

FIG. 8 is a schematic representation of an exemplary computer-based user-interface 800 (like the user-interfaces 702a-702f in FIG. 7).

The illustrated computer-based user-interface device 800 has a computer-based processor 802, a computer-based storage device 804, a computer-based memory 806 with software 808 stored therein that, when executed by the processor 802, causes the processor to provide functionality to support system operations as described herein, input and output (I/O) devices 810 (or peripherals), and a local bus, or local interface 812 that allows for internal communication within the computer-based processing device 806. The local interface 812 can be, for example, one or more buses or other wired or wireless connections. In various implementations, the computer-based processing device 806 may have additional elements, such as controllers, buffers (caches), drivers, repeaters, and receivers, to facilitate communications and other functionalities. Further, the local interface 812 may include address, control, and/or data connections to enable appropriate communications among the illustrated components.

The processor 802, in the illustrated example, is a hardware device for executing software, particularly that stored in the memory 806. The processor 802 can be any custom made or commercially available single core or multi-core processor, a central processing unit (CPU), an auxiliary processor among several processors, a semiconductor based microprocessor (in the form of a microchip or chip set), a macroprocessor, or generally any device for executing software instructions. In addition, the processing function can reside in a cloud-based service accessed over the internet.

The memory 806 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory 806 may incorporate electronic, magnetic, optical, and/or other types of storage media. The memory 806 can have a distributed architecture, with various memory components being situated remotely from one another, but accessible by the processor 802.

The software 808 includes one or more computer programs, each of which contains an ordered listing of executable instructions for implementing logical functions associated with the computer-based processing system 800, as described herein. The memory 806 may contain an operating system (O/S) 809 that controls the execution of one or more programs within the computer-based device 800, including scheduling, input-output control, file and data management, memory management, communication control and related services and functionality.

The I/O devices 810 may include one or more of any type of input or output device. Examples include a keyboard, mouse, scanner, microphone, printer, display, etc. In some implementations, a person having administrative privileges, for example, may access the computer-based processing device to perform administrative functions through one or more of the I/O devices 810.

In a typical implementation, the computer-based processing device 106 also includes a network interface that facilitates communication with one or more external components via a communications network. The network interface can be virtually any kind of computer-based interface device. In some instances, for example, the network interface may include one or more modulator/demodulators (i.e., modems); for accessing another device, system, or network), a radio frequency (RF) or other transceiver, a telephonic interface, a bridge, a router, or other device. During system operation, the computer-based user-interface device 800 receives data and sends notifications and other data via the network interface.

In some implementations, the systems and functionalities described herein can anticipate new forms of abusive tax behavior by optimizing both tax planning and auditing policy. Moreover, in some implementations, transaction sequences be constructed which minimize tax liability, while attracting minimal IRS suspicion. Moreover, IRS policy can be formed which assigns high auditing likelihood to suspicious transaction sequences, without falsely auditing routine transactions.

Different transaction sequences that produce the same economic result can generate very different tax consequences. Indeed, different methods of exiting a partnership can be strategic for both the exiting and existing partners. In a simplified example, a partner could sell their interest in a partnership or take a liquidating distribution and incur a certain tax liability. Alternatively, they could (1) take out a large loan through the partnership to increase their share of liabilities, then (2) sell a majority of their interest to a third party, while maintaining a negligible share in the partnership. This way, the partner receives close to the entire value of their interest in cash, while incurring a significantly smaller amount of tax.

Thus, assuming that there is a near infinite space of transaction sequences that produce the same (or similar) economic results, it can be a goal of the tax planner to choose the “best” sequence by searching over all combinations of transaction sequences. Some implementations of the methods disclosed herein assume that a transaction sequence is of high value if it produces low levels of tax liability without arising suspicion from the IRS, i.e. generating a high audit score.

Optimization of an audit score sheet is essentially a method for classifying an abusive tax shelter. That is, in some implementations, a goal is to find the joint occurrence of observable events which perfectly describe the shelter. Not only will this generally result in every similarly abusive transaction sequence to be audited, but will prevent against “false positive” audits on legitimate transaction sequences. Specifically, in some implementations, it is assumed that the value of an audit score sheet is based on a combination of the generated tax liability and the audit score. If a transaction sequence results in a low tax liability relative to other transaction sequences that produce similar economic results, then the audit score should be high.

Conversely, average or high levels of tax liability should be associated with a low audit score so as not to waste auditing resources on routine, non-abusive transactions.

Certain implementations of the techniques disclosed herein involve a method to search over a near infinite space of potential solutions, otherwise known as a search heuristic. Some of the techniques disclosed herein use a class of search heuristics known as Evolutionary Algorithms (EA). In some instances, tax planners and IRS policies co-evolve with one another. An algorithm based on neo-Darwinian concepts is a good method for finding optimal solutions. EAs generally use natural selection as the inspiration for finding an optimal solution in a near infinite search space. There are several steps to the process described below, and shown in FIGS. 4 & 5.

In some implementations, the population of solutions refers to either (a) transaction sequences, or (b) audit score sheets. When evolving transaction sequences, a single audit score sheet can be selected to evaluate the audit score for each potential solution. Conversely, a single transaction sequence can be selected to evaluate each audit score sheet against each evolving auditing procedures. Thus, each potential solution is assigned both a measure of taxable income, as well as an audit score. These metrics are used to select a subset of the best performing solutions, which may then be varied. Finally, the new population replaces the previous population, at which point the process is either repeated or terminated.

This process may be described as a “uni-directional” EA because both are being compared to a static objective. That is, all transaction sequences generate their audit score based on the same audit score sheet. Similarly, all audit score sheets are evaluated against the same transaction sequence.

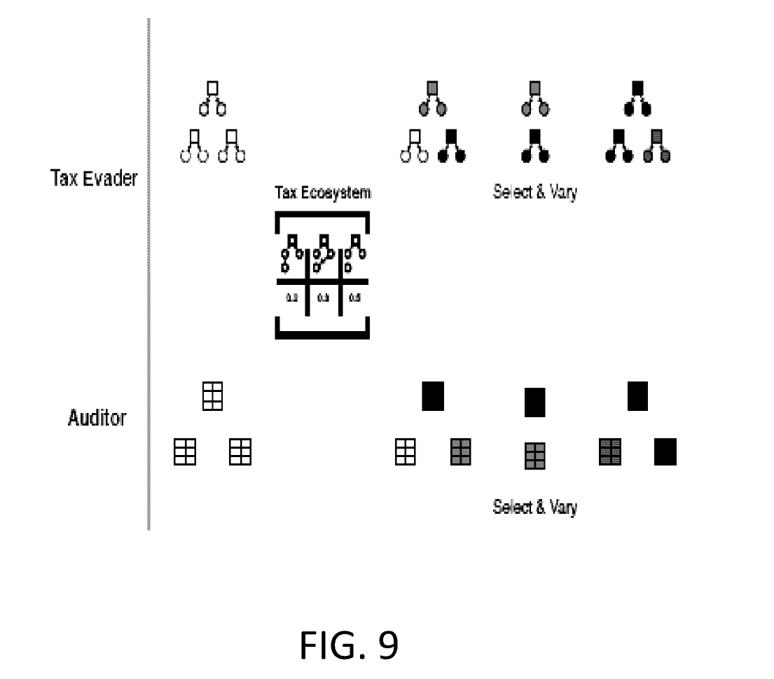

Given the two well-defined uni-directional EAs, a “bi-directional” EA, or a co-evolutionary algorithm, can be established. As shown in FIG. 9, a population of individual tax evaders (transaction sequences) is presented with a population of individual auditors (audit score sheets). Rather than evaluating each solution based on a single objective, multiple solutions from the opposing population are used.

Specifically, the evaluation process is expanded by
1. selecting a size k subset of the opposing population, then
2. calculating the total objective score as a function of the objective scores generated from all k evaluations.

In this way, the dynamics between potentially abusive tax shelters and the auditors' response can be studied. This is a step towards the goal of anticipating new iterations of abusive tax shelters.

In order to optimize using grammatical evolution, in some implementations, the techniques involve establishing a mapping between the set of positive integers and the object that we are attempting to optimize. The following optimization was implemented in Java as both a uni-directional and co-evolutionary search.

We can describe the process by which sequences of transactions and initial ownership network are generated by defining a mapping Ξ_{f}:Z₊^{o}→T×Γ that maps a list of n integers to an element in the set of sequences of transaction (T) and an element in the set of all ownership networks (P). Thus, for any xεxεZ₊ⁿ, Ξₜ(x)=(t,m) where tεT is a sequence of transactions and γₒεΓ is an initial network.

We can now define the space of auditing observables as Ψ, where for some mεZ+,

$$Ψ = \{ {\{ {b}_{i} \}}_{i = 0}^{m} \text{:} {b}_{i} ∈ [ 0 , 1 ] and {\sum }_{i = 0}^{m} {b}_{i} = 1 \} ⋐ {ℝ}_{+}^{m}$$

The map Ξₐ: [symbol] ₊ [symbol] Ψ maps a vector yε [symbol] ₊^{m} to an element in the set of auditing [symbol] behavior.

The function F can be broken up into a network of transition functions that has the same length as the number of transactions in the transaction set contained within the function call (k). Each transition function generates a new network state and an audit score. So for all iε[0,k], Fᵢ(tᵢ,γᵢ,ψ)=(γᵢ₊₁,sᵢ) where s=sₖ.

A goal of the tax evader may be to minimize both audit likelihood and taxable income. First of all, each set of transactions generates a taxable income, η. Secondly, an audit score sheet generates an audit score, s based on a network of transactions, which represents the likelihood that a scheme will be audited, i.e. the risk of being audited. Thus, we can represent the fitness function, hₑ for a tax evasion scheme, given a specific audit score sheet, as hₑ (η, s)

A goal of the auditor may be to maximize the likelihood of an audit of a network of transactions with low taxable income. The fitness function for an audit score sheet given a specific tax evasion scheme is a function which reflects such a relationship, represented by hₐ(η, s). An audit score sheet may be considered fit for a specific evasion scheme if either 1) there is not a suspiciously low amount of taxable income 2) if there is a high likelihood that if not much tax is collected, then the scheme will be audited.

In certain implementations, we describe how to judge the fitness of a network of transactions t and an auditing behavior ψ based on the taxable income η and audit score s generated from the tax ecosystem model F. Now it is possible to fully define the maximizing objectives of networks of transactions as

$$arg {max}_{{x}^{*} ∈ X} [ {h}_{e} ( F ( {Ξ}_{t} ( {x}^{*} ) , {Ξ}_{a} ( y ) ) ) ] = arg {max}_{{t}^{*} ∈ T , {γ}_{0}^{*} ∈ Γ} [ {h}_{e} ( F ( {t}^{*} , {γ}_{0}^{*} , ψ ) ) ]$$

over all yεB(ŷ,r₁) for some ŷε [symbol] ₊^{m}, where B(ŷ,r₁) is a ball of radius r₁ε [symbol] ₊ around [symbol] ŷ. This represents the fact that the goal of the GA is to find local maxima around some subset of auditing behavior, rather than attempting to search the entire Φ space. Conversely, the objective for the auditing behaviors is to maximize the hₐ function, i.e. the goal is

$$arg {max}_{{y}^{*} ∈ {ℤ}_{+}^{m}} [ {h}_{a} ( F ( {Ξ}_{t} ( x ) , {Ξ}_{a} ( {y}^{*} ) ) ) ] = arg {max}_{{ψ}^{*} ∈ Ψ} [ {h}_{a} ( F ( t , {γ}_{0} , {ψ}^{*} ) ) ]$$

over all xεB(\hat{x},r₂) for some \hat{x}ε\hat{X}, where B(\hat{x},r₂) is ball of radius r₂ε [symbol] ₊ around \hat{x}. This represents the fact that the EA only searches for local maxima around a subset of all transaction sets and initial model states.

Three experiments were run on to determine which tax evasion schemes a particular genetic algorithm (GA) calculated as optimal. All experiments began with a population size of 100, and iterated for 10 generations. The first experiment was run 200 times, and the second two were run 100 times, with a few runs outputting invalid data.

Given that the particular model was designed to detect the Installment Sale Bogus Optional Basis Transaction (iBOB) schemes, it is important to understand how evasion schemes can generate no final tax that do not share the iBOB structure.

The table below describes the results of the three experiments. Recall that each run generates a single tax evasion scheme that is the “winner” of the GA that generates a certain amount of tax. The data shown are the number of runs, the number of those schemes that generated zero tax, then information regarding how many of those “winning” evasion schemes fit the iBOB structure.

| | | # w/ | | | % iBOB w/ |
|---|---|---|---|---|---|
| exp # | # of runs | tax = 0.0 | # iBOB | % iBOB total | tax = 0.0 |
| 1 | 178 | 178 | 9 | 5.1% | 5.1% |
| 2 | 98 | 73 | 13 | 13.3% | 17.8% |
| 3 | 97 | 18 | 17 | 17.5% | 94.4% |

Each tax evasion scheme generated in the first experiment yielded zero tax liability, but very few of them fit the iBOB structure. It was noticed that many of the resulting tax evasion schemes involved transactions in which two “linked” entities would exchange assets, usually resulting in a 754 election.

In this context, “linked” is defined as whenever Jones, JonesCo or NewCo engage in a transaction with one another. While the model allows for this to occur, this may be an unrealistic scenario due to high risk of detection. To remedy this, an audit score was included that detracted an arbitrary amount from a tax evasion scheme's fitness if a “linked” transaction was detected in the scheme, which was the basis for experiment 2.

While the second experiment yielded both a greater percentage of iBOB schemes and a wider variety in final tax liabilities of the evasion schemes, a vast majority of “winning” transactions that generated no tax were not iBOB. In most of those cases, prior to the final sale of the Hotel to Brown for cash, an entity would purchase the Hotel for a $200 Annuity. Thus, that transaction would both accumulate no tax because an Annuity asset was involved, while invoking a 754 election on the Hotel and stepping-up its basis. Due to the suspicious nature of this type of transaction, the audit score was augmented to detect transactions that involved exchanging an Annuity asset for a Material asset, resulting in experiment 3.

Only one of the runs that generated zero tax in experiment 3 was not iBOB, which is very promising.

By accounting for transactions between linked entities and exchanges of Annuities for Material, the GA was able to more efficiently evolve iBOB schemes, as opposed to the highly suspicious schemes that composed the majority of the previous runs.

A number of embodiments of the invention have been described. Nevertheless, it will be understood that various modifications may be made without departing from the spirit and scope of the invention.

For example, the processes can be varied herein, with different steps being performed in a different order than described herein. Some of the steps may be performed in parallel or series.

Indeed, in some implementations, some of the steps may be omitted entirely. The techniques can be applied in a variety of contexts, only one of which being in tax. Consider, as a relatively simple example, a particular transaction sequence that includes three characteristics: 1) a sale of partnership asset, 2) the partnership that was involved in the sale had no 754 election, and 3) there was a large built-in loss in the sale. Under section 754 of the US tax code, a partnership may elect to adjust the basis of partnership property when property is distributed or when a partnership interest is transferred. Generally speaking, any one of these three characteristics, on its own, is probably not suspicious at all, and would not suggest that anything abusive has occurred. However, together, depending on the applicable tax laws and auditing policies, this particular sequence may be worth investigating or auditing more closely. In a typical implementation, the techniques disclosed herein, depending on the applicable tax laws and auditing policies, would flag this transaction sequence as having some likelihood of being abusive. Thus, in some instances, an auditor, relying on these techniques may have fewer misses and become far more effective in his or her auditing role. Other applications may be useful as well.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

Computer-readable instructions to implement one or more of the techniques disclosed herein can be stored on a computer storage medium. Computer storage mediums (e.g., a non-transitory computer readable medium) can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” (e.g., a processor or the like) encompasses all kinds of apparatus, devices, and machines for processing data, including by way of example a programmable processor, a computer, a system on a chip, or multiple ones, or combinations, of the foregoing. Moreover, use of the term data processing apparatus should be construed to include multiple data processing apparatuses working together. Similarly, use of the term memory or memory device or the like should be construed to include multiple memory devices working together.

Computer programs (also known as programs, software, software applications, scripts, or codes) can be written in any form of programming language, including compiled or interpreted languages, declarative or procedural languages, and can be deployed in any form.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both.

A computer device adapted to implement or perform one or more of the functionalities described herein can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including, for example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented using a computer device having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

This document refers to populations throughout. In a typical implementation, a population may be, for example, a multiset.

Finally, the IRS is mentioned as one exemplary organization that might conduct a tax audit. However, audits, of course, can be performed by anyone; they need not be performed by the IRS.

Other details of exemplary implementations and various steps thereof are described in the attached documents as well.

Other implementations are within the scope of this document.

What is claimed is:

1. A computer-based method comprising:
mapping a first subset of integers to a plurality of transaction sequences;
mapping a second subset of integers to a plurality of audit score sheets;
quantitatively analyzing each respective one of the mapped transaction sequences relative to each respective one of the mapped audit score sheets to determine an objective score for each one of the transaction sequences and each one of the audit score sheets,
wherein the objective score for each one of the mapped transaction sequences is a function of an estimated tax liability and likelihood of being audited associated with that mapped transaction sequence, and
wherein the objective score for each one of the mapped audit score sheets is a function of an estimated effectiveness associated with that audit score sheet; and
generating a new population of effective transaction sequences and/or effective auditing policies based on the objective scores.

2. The computer-based method of claim 1, wherein the quantitative analysis comprises:
estimating the tax liability associated with each one of the transaction sequences in view each one of an associated plurality of the audit score sheets, and/or
estimating the likelihood of being audited associated with each one of auditing policies in view of each one of an associated plurality of the transaction sequences.

3. The computer-based method of claim 1, further comprising generating the plurality of integers.

4. The computer-based method of claim 1, wherein generating the new population of effective transaction sequences and/or effective auditing policies based on the objective scores comprises:
applying a generic algorithm, or other evolutionary or non-linear search functionalities, to:
a plurality of the transaction sequences with the associated objective scores, and/or
a plurality of the auditing policies with the associated objective scores.

5. The computer-based method of claim 1, further comprising:
adjusting behavior of a taxpayer and/or an auditor in view of the new population of effective transaction sequences and/or effective auditing policies.

6. The computer-based method of claim 1, further comprising:
reiterating the qualitative analysis using the new population of effective transaction sequences and/or effective auditing policies as inputs.

7. The computer-based method of claim 6, further comprising:
continuing to reiterate until a halting condition is reached.

8. The computer-based method of claim 1, further comprising:
receiving information, at a computer-based processing system over a network from a computer-based user interface device, about the plurality of transaction sequences;
receiving information, by the computer-based processing system over the network, about one or more tax laws or the auditing policies.

9. The computer-based method of claim 8, wherein one or more processors in the computer-based processing system perform the quantitative analysis.

10. The computer-based method of claim 9, further comprising:
outputting, at one or more of the computer-based user interface devices, information about the new population of effective transaction sequences and/or effective auditing policies based on the objective scores.

11. The computer-based method of claim 1, wherein a particular one of the transaction sequences is considered effective if it accomplishes an economic goal, without incurring high tax liability, and while minimizing a likelihood of scrutiny under existing, applicable tax laws and auditing policies, and/or
wherein a particular tax law or one of the auditing policies is considered effective if it successfully flags every abusive or likely abusive scheme without unnecessarily flagging any schemes that are clearly not abusive.

12. The computer-based method of claim 5, further comprising:
feeding each individual mapped transaction sequence and/or each individual mapped audit score sheet into a sub-system, wherein the sub-system is configured to estimate:
taxable income and likelihood of being audited for each individual one of the mapped transaction sequences based on every single one of an associated plurality of the audit score sheets, and/or
effectiveness of each individual one of the auditing policies based on every one of a plurality of the transaction sequences.

13. The computer-based method of claim 6, wherein the sub-system further assigns one of the objective score to each one of the transaction sequences and/or audit score sheets.

14. A computer system comprising:
a processor; and
a memory storage device, wherein the memory storage device stores data that causes the processor to:
map a first subset of integers to a plurality of transaction sequences;
map a second subset of integers to a plurality of audit score sheets;
quantitatively analyze each respective one of the mapped transaction sequences relative to each respective one of the mapped audit score sheets to determine an objective score for each one of the transaction sequences and each one of the audit score sheets,
wherein the objective score for each one of the mapped transaction sequences is a function of an estimated tax liability and likelihood of being audited associated with that mapped transaction sequence, and
wherein the objective score for each one of the mapped audit score sheets is a function of an estimated effectiveness associated with that audit score sheet; and
generate a new population of effective transaction sequences and/or effective auditing policies based on the objective scores.

15. A non-transitory, computer-readable medium that stores instructions executable by a processor to perform the steps comprising:
mapping a first subset of integers to a plurality of transaction sequences;
mapping a second subset of integers to a plurality of audit score sheets;
quantitatively analyzing each respective one of the mapped transaction sequences relative to each respective one of the mapped audit score sheets to determine an objective score for each one of the transaction sequences and each one of the audit score sheets,
wherein the objective score for each one of the mapped transaction sequences is a function of an estimated tax liability and likelihood of being audited associated with that mapped transaction sequence, and
wherein the objective score for each one of the mapped audit score sheets is a function of an estimated effectiveness associated with that audit score sheet; and
generating a new population of effective transaction sequences and/or effective auditing policies based on the objective scores.
